(19) United States
(12) Patent Application Publication
(10) Pub. No.: US 2024/0394863 A1
(43) Pub. Date: Nov. 28, 2024

(54) INFORMATION PROCESSING DEVICE, SUPPORT SYSTEM, AND SUPPORT METHOD

(71) Applicant: Mitsubishi Electric Corporation, Tokyo (JP)

(72) Inventors: Takahiro KASHIMA, Tokyo (JP); Kotoyu SASAYAMA, Tokyo (JP); Yoshie IMAI, Tokyo (JP); Yusuke ITANI, Tokyo (JP); Yusuke NAGAI, Tokyo (JP); Yoshimi MORIYA, Tokyo (JP); Atsushi HORI, Tokyo (JP); Yuichi SASAKI, Tokyo (JP); Shoki MIYAGAWA, Tokyo (JP); Toru AOKI, Tokyo (JP); Isamu OGAWA, Tokyo (JP); Saki ITO, Tokyo (JP); Naoyuki TSUSHIMA, Tokyo (JP)

(73) Assignee: Mitsubishi Electric Corporation, Tokyo (JP)

(21) Appl. No.: 18/795,950

(22) Filed: Aug. 6, 2024

Related U.S. Application Data
(63) Continuation of application No. PCT/JP2022/010021, filed on Mar. 8, 2022.

(51) Int. Cl. G06T 7/00; G06T 7/70; G06V 20/62; G06V 30/10

(52) U.S. Cl. CPC G06T 7/0002; G06T 7/70; G06V 20/63; G06V 30/10; G06V 2201/07

(57) ABSTRACT

An information processing device includes an acquisition unit that acquires an image indicating a board including a name of the board and an inspection target and a position table as information indicating a correspondence relationship among the name of the board, a position of the inspection target, and a name of the inspection target, a detection unit that detects the board based on the image, detects the name of the board in an image region indicating the board, and detects the position of the inspection target based on the image region indicating the board, and an association unit that associates the board and the inspection target with each other based on the name of the board, the position of the inspection target, and the position table.

### CROSS-REFERENCE TO RELATED APPLICATION

This application is a continuation application of International Application No. PCT/JP2022/010021 having an international filing date of Mar. 8, 2022.

### BACKGROUND OF THE INVENTION

### 1. Field of the Invention

The present disclosure relates to an information processing device, a support system, and a support method.

### 2. Description of the Related Art

A control board, a power board, a distribution board, and so forth are installed in a facility like a power plant. These boards are inspected routinely or periodically. These boards include meters or the like. The meters or the like are inspection targets. Here, a technology for extracting display content of a meter has been proposed (see Patent Reference 1).
Patent Reference 1: Japanese Patent Application Publication No. 2018-181232

In the aforementioned technology, content of an inspection target is extracted. However, the technology is incapable of recognizing what board is the board including the inspection target whose content is being extracted. Therefore, an inspector needs to manually make association between each inspection target and the board including the inspection target. For example, the inspector performs the work of making the association by using a computer. The work performed by the inspector increases the load on the inspector.

### SUMMARY OF THE INVENTION

An object of the present disclosure is to reduce the load.

An information processing device according to an aspect of the present disclosure is provided. The information processing device includes an acquisition unit that acquires an image indicating a board including a name of the board and an inspection target and position information as information indicating a correspondence relationship among the name of the board, a position of the inspection target, and a name of the inspection target, a detection unit that detects the board based on the image, detects the name of the board in an image region indicating the board, and detects the position of the inspection target based on the image region indicating the board, and an association unit that associates the board and the inspection target with each other based on the name of the board, the position of the inspection target, and the position information.

According to the present disclosure, the load can be reduced.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing a support system in a first embodiment;

FIG. 2 is a diagram showing hardware included in an information processing device in the first embodiment;

FIG. 3 is a block diagram showing functions of the information processing device in the first embodiment;

FIG. 4 is a diagram showing an example of a position table in the first embodiment;

FIG. 5 is a diagram showing an example of detection of a board in the first embodiment;

FIG. 6 is a diagram showing an example of an image of association in the first embodiment;

FIG. 7 is a flowchart showing an example of a process executed by the information processing device in the first embodiment;

FIG. 8 is a diagram showing a support system in a second embodiment;

FIG. 9 is a block diagram showing functions of an information processing device in the second embodiment;

FIG. 10 is a block diagram showing functions of an information processing device in a third embodiment;

FIG. 11 is a diagram showing an example of a case where an inspection result is displayed in a fourth embodiment; and

FIG. 12 is a block diagram showing functions of a mobile terminal in a fifth embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

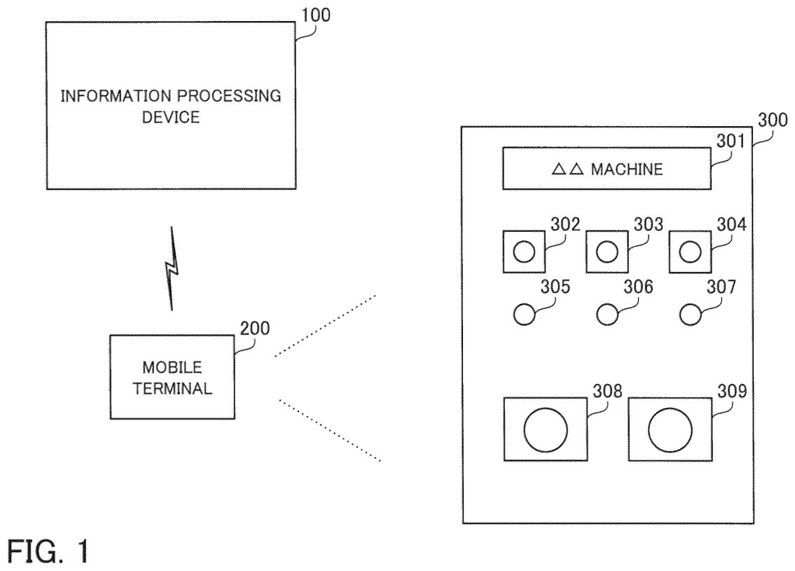

FIG. 1 is a diagram showing a support system in a first embodiment. The support system includes an information processing device 100 and a mobile terminal 200. The information processing device 100 and the mobile terminal 200 are connected to each other via a network.

The information processing device 100 is a device that executes a support method. The mobile terminal 200 is a device used by an inspector. For example, the mobile terminal 200 is a smartphone, a tablet terminal or a Head Mounted Display (HMD). The mobile terminal 200 includes an image capturing unit.

A board 300 is shown in FIG. 1. For example, the board 300 is a control board, a power board, a distribution board or the like. The board 300 includes a nameplate 301, switches 302 to 304, lamps 305 to 307, and meters 308 and 309.

A name of the board 300 is inscribed on the nameplate 301. The switches 302 to 304, the lamps 305 to 307, and the meters 308 and 309 are inspection targets.

The inspector photographs the board 300 by using the mobile terminal 200. Then, the mobile terminal 200 transmits an image indicating the board 300 to the information processing device 100. The information processing device 100 automatically associates the board 300 and the inspection targets with each other based on the image. Thus, the inspector does not need to manually make the association between each inspection target and the board including the inspection target. Accordingly, the information processing device 100 is capable of reducing the load on the inspector.

In the following, the information processing device 100 will be described in detail.

First, hardware included in the information processing device 100 will be described below.

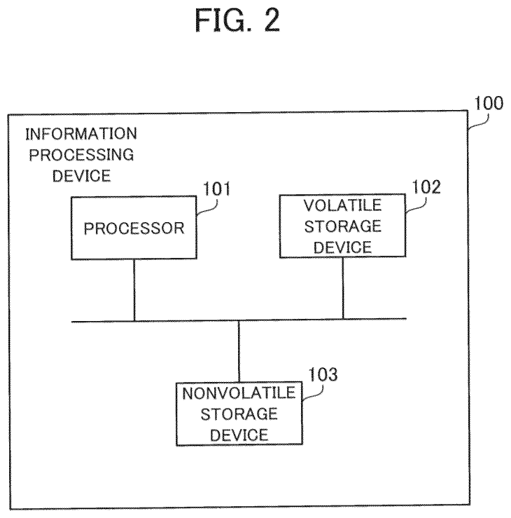

FIG. 2 is a diagram showing the hardware included in the information processing device in the first embodiment. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions included in the information processing device 100 will be described below.

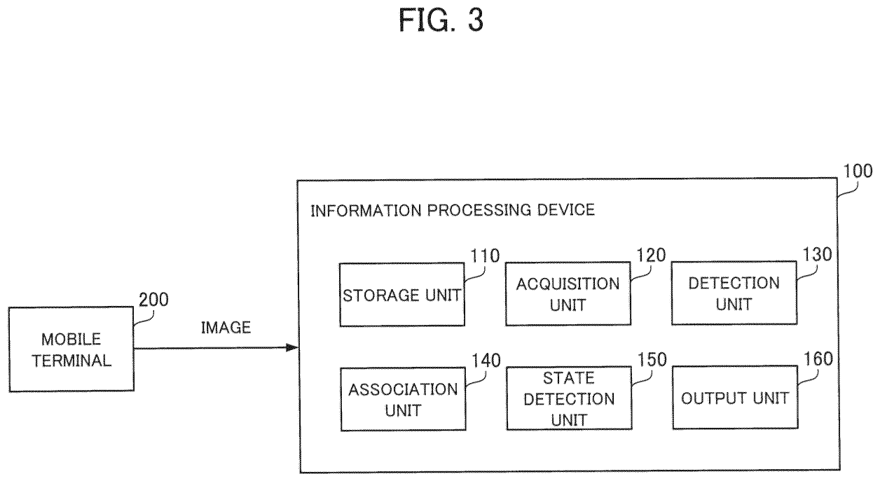

FIG. 3 is a block diagram showing the functions of the information processing device in the first embodiment. The information processing device 100 includes a storage unit 110, an acquisition unit 120, a detection unit 130, an association unit 140, a state detection unit 150 and an output unit 160.

Incidentally, the state detection unit 150 may be referred to also as an inspection unit.

The storage unit 110 may be implemented as a storage area reserved in the volatile storage device 102 or the nonvolatile storage device 103.

Part or all of the acquisition unit 120, the detection unit 130, the association unit 140, the state detection unit 150 and the output unit 160 may be implemented by processing circuitry. Further, part or all of the acquisition unit 120, the detection unit 130, the association unit 140, the state detection unit 150 and the output unit 160 may be implemented as modules of a program executed by the processor 101. For example, the program executed by the processor 101 is referred to also as a support program. The support program is recorded in a record medium, for example.

The storage unit 110 may store a position table. Here, the position table will be shown below.

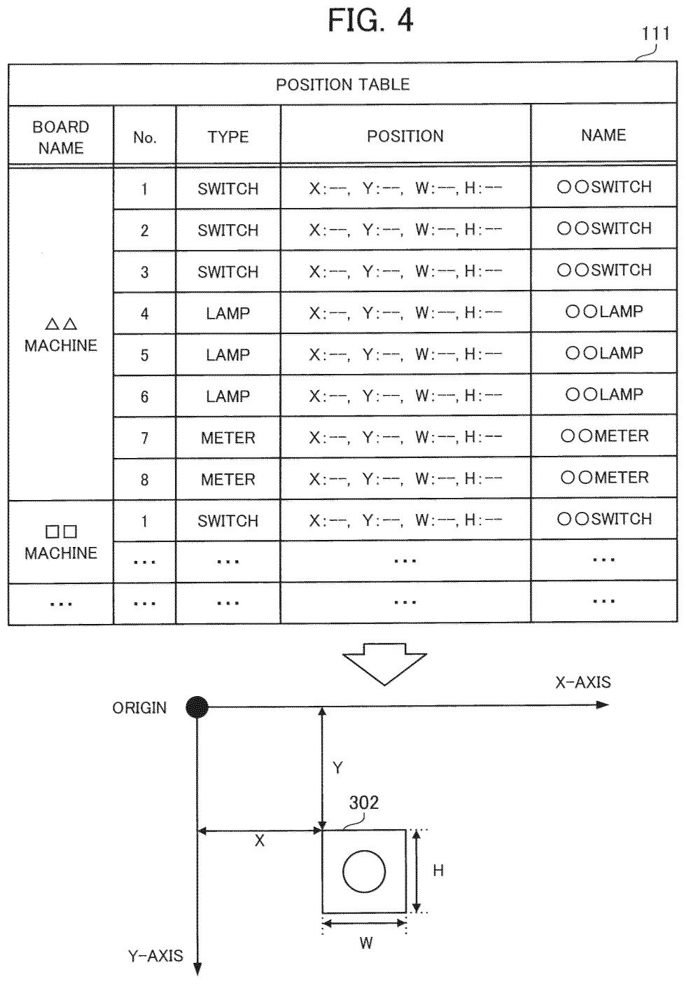

FIG. 4 is a diagram showing an example of the position table in the first embodiment. For example, the position table 111 has been stored in the storage unit 110. The position table 111 is referred to also as position information. The position table 111 is information indicating a correspondence relationship among the name of the board, a position of an inspection target, and a name of the inspection target. The position table 111 will be explained in detail below. The position table 111 includes items of “board name”, “No.”, “type”, “position” and “name”. For example, the name of the board is registered in the item of “board name”. The position of each inspection target is registered in the item of “position”. The name of each inspection target is registered in the item of “name”.

“No. 1” in the board name “ΔΔ machine” indicates the position of the switch 302. For example, the position of the switch 302 is represented by a distance (i.e., X, Y) from an origin. Further, widths of the switch 302 are represented by W and H. Incidentally, the origin is a corner of the board 300.

The origin can also be the position of the nameplate 301. The position of the inspection target may also be represented by coordinates of a central point of the inspection target. In short, the representation of the position of the inspection target may also be representation other than the position in the position table 111 in FIG. 4. For example, the position of the inspection target may also be represented by a ratio relative to the width of the board. Further, for example, the position of the inspection target may also be represented by coordinates of four corners of the inspection target. For example, the position of the inspection target may also be represented by a circle made up of coordinates of the central point and a radius. The position of the inspection target may also be represented by a region of the inspection target. Further, the unit of the position can be a physical length such as cm or m.

The acquisition unit 120 acquires the image generated by the mobile terminal 200.

The acquisition unit 120 acquires the position table 111. For example, the acquisition unit 120 acquires the position table 111 from the storage unit 110. Alternatively, for example, the acquisition unit 120 acquires the position table 111 from an external device. Incidentally, illustration of the external device is left out.

The detection unit 130 detects the board 300 based on the image. For example, the detection unit 130 detects the board 300 based on the image and a learned model. Alternatively, for example, the detection unit 130 detects the board 300 based on the image and information indicating the shape of the board 300. Incidentally, the learned model and the information indicating the shape of the board 300 may be stored in the storage unit 110 or an external device. An example of the detection of the board 300 will be described below.

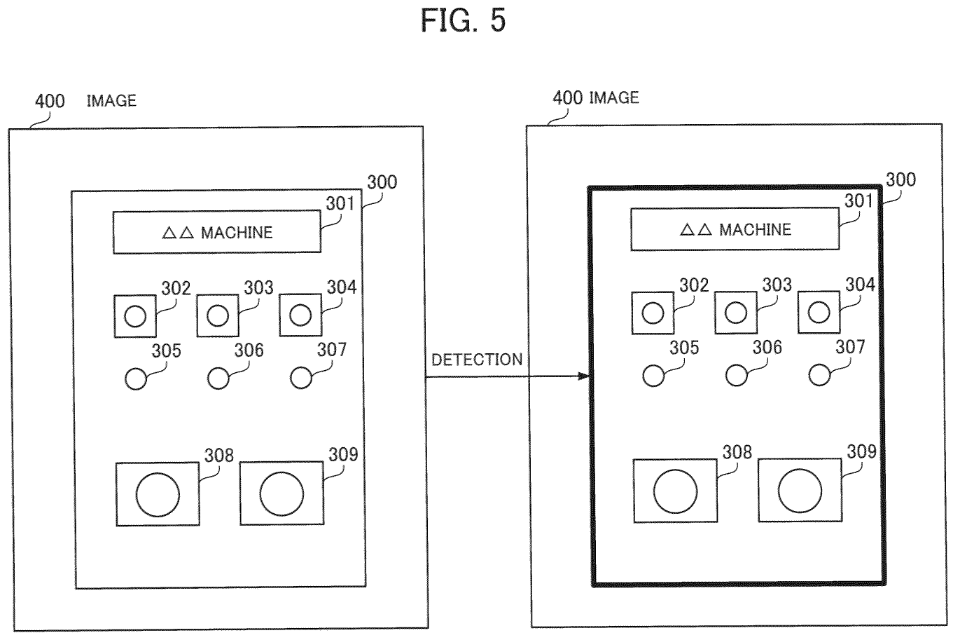

FIG. 5 is a diagram showing an example of the detection of the board in the first embodiment. The image 400 is the image generated by the mobile terminal 200. As shown in FIG. 5, the detection unit 130 detects the board 300. Precisely, the detection unit 130 detects the shape of the board 300. That is, the detection unit 130 detects a rectangle. Alternatively, the detection unit 130 may detect four points representing four corners of the board 300.

The detection unit 130 detects the name of the board 300 in an image region indicating the board 300. Specifically, the detection unit 130 performs character recognition on the image region of the board 300. When performing the character recognition, the detection unit 130 may use Optical Character Recognition (OCR). By this, the detection unit 130 detects the name “ΔΔ machine” of the board 300 indicated by the nameplate 301.

The detection unit 130 detects the position of each inspection target based on the image region indicating the board 300. Specifically, the detection unit 130 is capable of detecting the position of the inspection target by detecting the inspection target by use of object recognition technology. By this, the detection unit 130 detects the positions of the switch 302 and the like. Further, the position as the detection result may be represented by a corner and widths of the inspection target as shown in FIG. 4.

The association unit 140 associates the board 300 and each inspection target with each other based on the name of the board 300, the position of each inspection target, and the position table 111. Specifically, the association unit 140 identifies the name “ΔΔ machine” of the board 300 out of the “board name” in the position table 111. The association unit 140 identifies the name of each inspection target based on records of the “position” in the “ΔΔ machine” in the position table 111 and the position of the inspection target. The association unit 140 associates the name “ΔΔ machine” of the board 300 and the name of the inspection target with each other. An image of the association will be shown below.

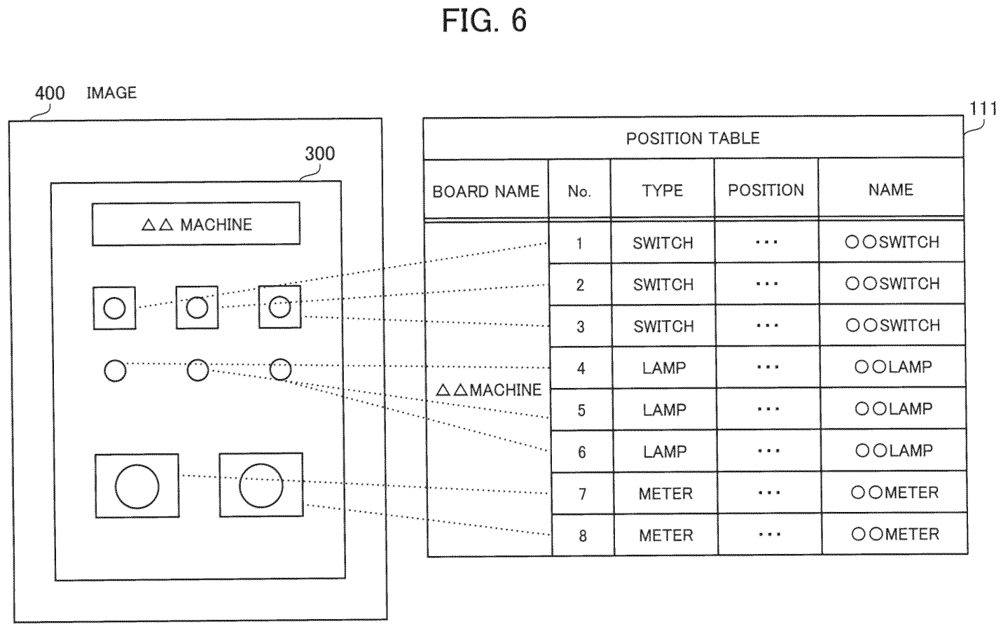

FIG. 6 is a diagram showing an example of the image of the association in the first embodiment. As shown in FIG. 6, the board 300 and the inspection targets are associated with each other.

The state detection unit 150 detects the state of each inspection target in the image. In more detail, the state detection unit 150 detects the state of each inspection target by using image analysis technology or a learned model. Specifically, the state detection unit 150 detects whether a switch is in an ON state or an OFF state. Further, the state detection unit 150 detects whether a lamp is blinking or not. Furthermore, the state detection unit 150 detects a value indicated by a meter.

The output unit 160 outputs an inspection result as a detection result to the mobile terminal 200. Accordingly, the inspector can check the state of each inspection target via the mobile terminal 200. Incidentally, the inspection result is, for example, information in which the name “ΔΔ machine” of the board 300, the name “OO switch” of an inspection target, and the state “ON” of the inspection target have been associated with each other.

Next, a process executed by the information processing device 100 will be described below by using a flowchart.

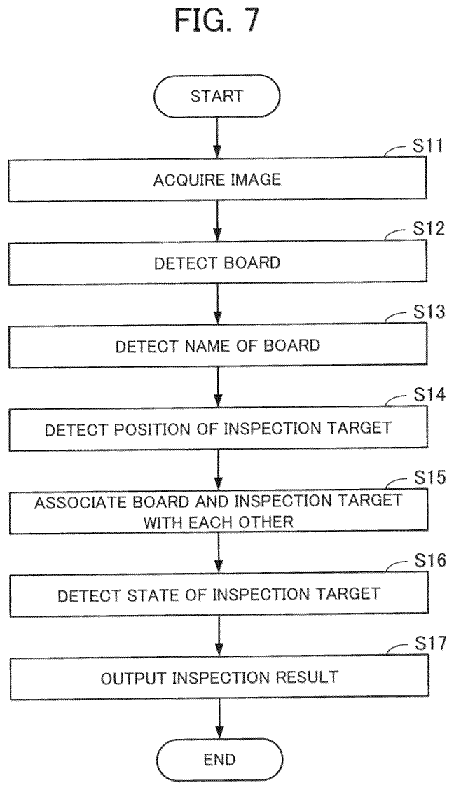

FIG. 7 is a flowchart showing an example of the process executed by the information processing device in the first embodiment.

(Step S11) The acquisition unit 120 acquires the image generated by the mobile terminal 200.

(Step S12) The detection unit 130 detects the board 300 based on the image.

(Step S13) The detection unit 130 detects the name of the board 300 based on the image.

(Step S14) The detection unit 130 detects the position of an inspection target based on the image.

(Step S15) The association unit 140 associates the board 300 and the inspection target with each other based on the name of the board 300, the position of the inspection target, and the position table 111.

(Step S16) The state detection unit 150 detects the state of the inspection target in the image.

(Step S17) The output unit 160 outputs the inspection result to the mobile terminal 200.

According to the first embodiment, the information processing device 100 associates the board 300 and the inspection targets with each other. Thus, the inspector does not need to manually make the association between each inspection target and the board including the inspection target. Accordingly, the information processing device 100 is capable of reducing the load on the inspector.

### Second Embodiment

Next, a second embodiment will be described below. In the second embodiment, the description will be given mainly of features different from those in the first embodiment. In the second embodiment, the description is omitted for features in common with the first embodiment.

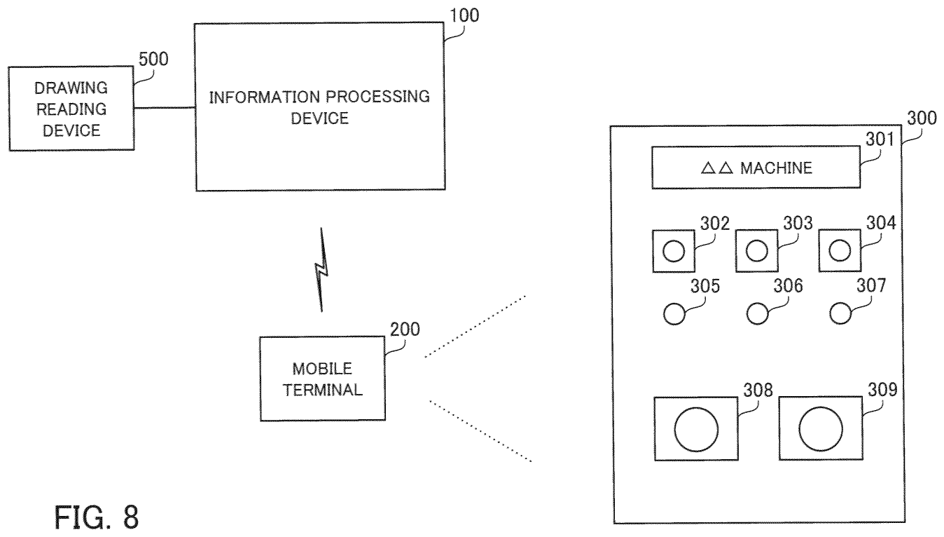

FIG. 8 is a diagram showing a support system in the second embodiment. The support system may include an information processing device 100, the mobile terminal 200 and a drawing reading device 500.

The drawing reading device 500 reads out a design drawing of the board 300 (i.e., paper medium). The drawing reading device 500 may transmit a drawing indicating the board 300 obtained by reading out the design drawing to the information processing device 100. Further, the drawing reading device 500 may be included in the mobile terminal 200.

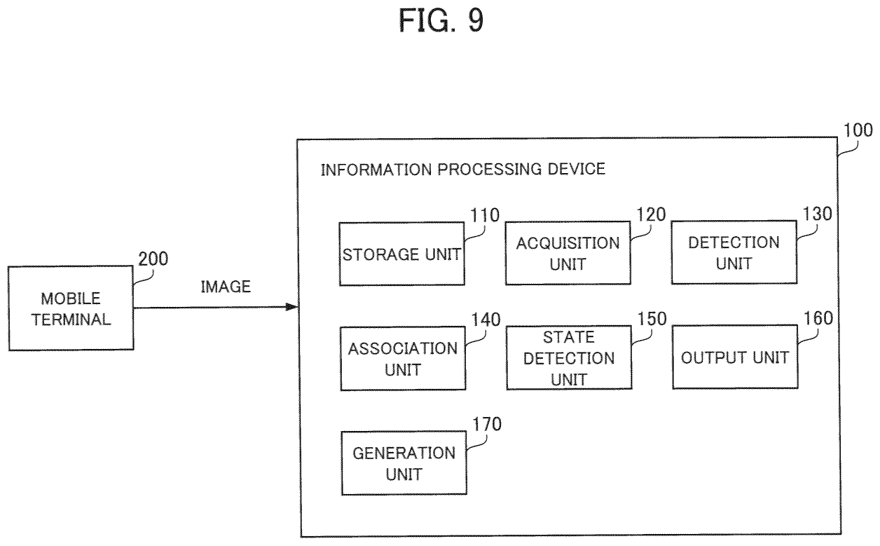

FIG. 9 is a block diagram showing functions of the information processing device in the second embodiment. Each component in FIG. 9 that is the same as a component shown in FIG. 3 is assigned the same reference character as in FIG. 3. The information processing device 100 further includes a generation unit 170. Part or the whole of the generation unit 170 may be implemented by processing circuitry. Further, part or the whole of the generation unit 170 may be implemented as a module of a program executed by the processor 101.

The acquisition unit 120 may acquire the drawing indicating the board 300 from the drawing reading device 500. Here, the information processing device 100 may have a drawing reading function. In the case where the information processing device 100 has the drawing reading function, the acquisition unit 120 acquires a drawing indicating the board 300 read out by the information processing device 100.

Further, the acquisition unit 120 may acquire a Computer-Aided Design (CAD) drawing as a design drawing of the board 300. The CAD drawing is the drawing indicating the board 300. For example, the acquisition unit 120 acquires the CAD drawing from the storage unit 110.

The generation unit 170 generates the position table 111 based on the drawing indicating the board 300. The output unit 160 outputs the position table 111 to the storage unit 110 or an external device.

According to the second embodiment, the position table 111 is generated automatically. Thus, the inspector is relieved of performing work of generating the position table 111, for example. Accordingly, the information processing device 100 is capable of reducing the load on the inspector.

### Third Embodiment

Next, a third embodiment will be described below. In the third embodiment, the description will be given mainly of features different from those in the first embodiment. In the third embodiment, the description is omitted for features in common with the first embodiment.

In the first embodiment, the description has given of the case where the inspection result is outputted. After the inspection result is outputted to the mobile terminal 200, the inspection result disappears in the information processing device 100. Thus, the fact that the inspection has been carried out is lost. Therefore, in the third embodiment, the description will be given of a case where the inspection result is stored in the information processing device 100.

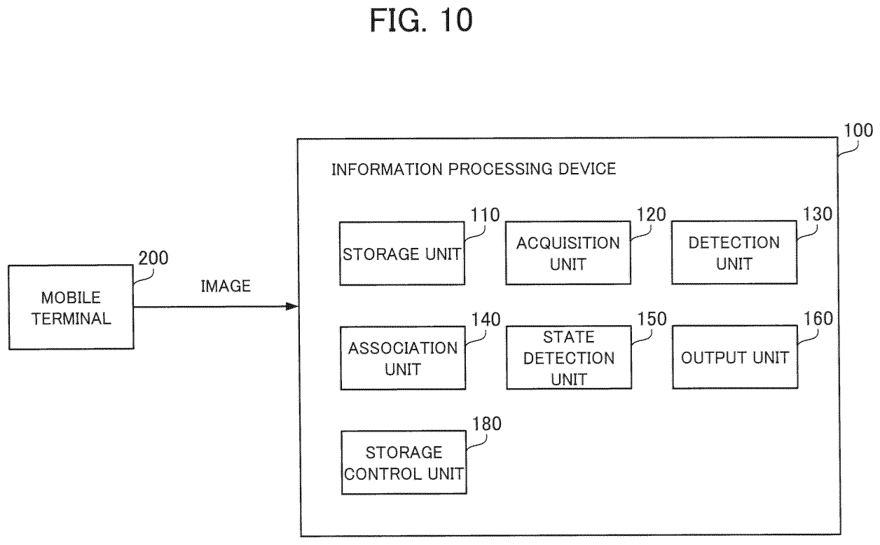

FIG. 10 is a block diagram showing functions of the information processing device in the third embodiment. Each component in FIG. 10 that is the same as a component shown in FIG. 3 is assigned the same reference character as in FIG. 3. The information processing device 100 further includes a storage control unit 180. Part or the whole of the storage control unit 180 may be implemented by processing circuitry. Further, part or the whole of the storage control unit 180 may be implemented as a module of a program executed by the processor 101.

The storage control unit 180 stores an inspection result including inspection date and time in the storage unit 110.

According to the third embodiment, the information processing device 100 stores the inspection result. Accordingly, the information processing device 100 is capable of retaining the fact that the inspection has been carried out.

### Fourth Embodiment

Next, a fourth embodiment will be described below. In the fourth embodiment, the description will be given mainly of features different from those in the third embodiment. In the fourth embodiment, the description is omitted for features in common with the third embodiment.

In the third embodiment, the description has given of the case where the inspection result is stored in the information processing device 100. Here, the inspection result is the result of inspection by a machine. The inspector needs to perform the inspection also by using the inspector's own eyes. In short, the inspector needs to check whether the inspection result is correct or not also by using the inspector's own eyes. Therefore, in the fourth embodiment, the description will be given of a case where a double check is made.

In the fourth embodiment, the mobile terminal 200 is an HMD. The information processing device 100 transmits the inspection result to the HMD. Accordingly, the HMD displays the inspection result. A case where the HMD displays the inspection result is shown below.

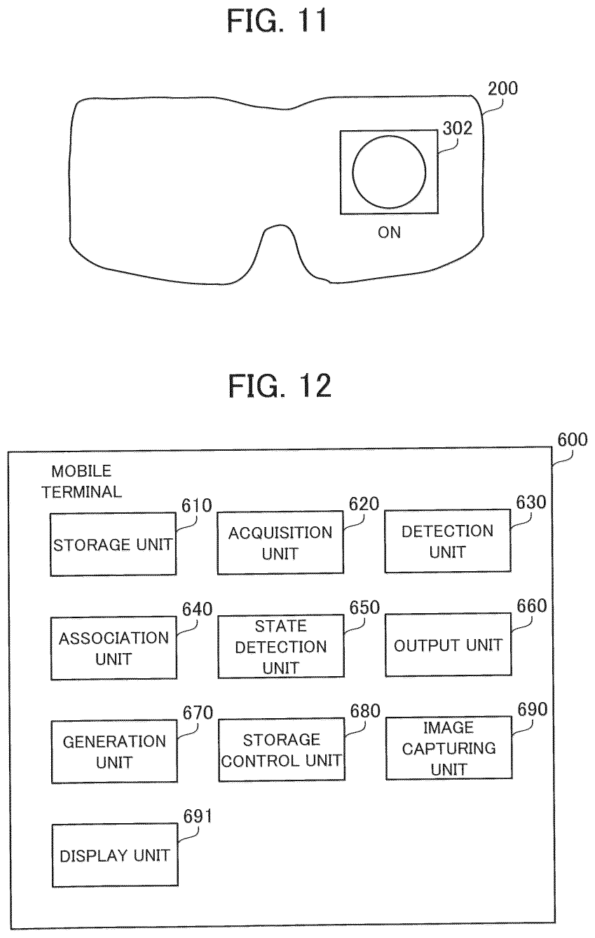

FIG. 11 is a diagram showing an example of the case where the inspection result is displayed in the fourth embodiment. As shown in FIG. 11, the inspection result is displayed by a display (referred to also as a display unit, for example) of the HMD. For example, a fact that the switch 302 is in the ON state is displayed by the display.

The HMD has been attached to the inspector. Incidentally, the inspector is referred to also as a user. The inspector is capable of recognizing the inspection result by viewing the display. Here, the HMD includes the image capturing unit. The image capturing unit may be regarded as a camera. Further, the HMD includes a detection unit. The detection unit detects via the image capturing unit that the inspector has viewed the inspection result. Specifically, the detection unit detects via the image capturing unit that the end of the inspector's line of sight is a spot where the inspection result is currently displayed. Further, the detection unit may judge that the inspector has viewed the inspection result if the inspector viewed the inspection result for 0.5 seconds, for example.

Furthermore, the HMD includes an acquisition unit. The acquisition unit acquires positional relationship information indicating a positional relationship between the image capturing unit and the display. Incidentally, the positional relationship information has been stored in a storage unit of the HMD, for example. Further, the acquisition unit acquires sight line information indicating the inspector's line of sight. Incidentally, the sight line information is calculated based on information acquired from the image capturing unit, for example. The detection unit detects an inspection target viewed by the inspector based on the positional relationship information, the sight line information, and an image obtained by the image capturing unit by photographing the scene in the direction of the line of sight. For example, the detection unit detects that the inspector viewed the switch 302.

The HMD transmits information indicating that the inspector viewed the inspection result and information indicating the inspection target viewed by the inspector to the information processing device 100.

The acquisition unit 120 acquires the information indicating that the inspector viewed the inspection result and the information indicating the inspection target viewed by the inspector.

When the target of the inspection result viewed by the inspector (i.e., the inspection result displayed by the display) coincides with the inspection target viewed by the inspector (i.e., the inspection target detected by the detection unit) based on the information indicating that the inspector viewed the inspection result and the information indicating the inspection target viewed by the inspector, the storage control unit 180 stores information indicating that the double check has been made in the storage unit 110. For example, the storage control unit 180 stores the information indicating that the double check has been made in the storage unit 110 when the target “switch 302” of the inspection result displayed by the display coincides with the inspection target “switch 302” viewed by the inspector.

According to the fourth embodiment, the information processing device 100 is capable of memorizing the fact that the double check has been made.

### Fifth Embodiment

Next, a fifth embodiment will be described below. In the fifth embodiment, the description will be given mainly of features different from those in the first to fourth embodiments. In the fifth embodiment, the description is omitted for features in common with the first to fourth embodiments.

In the first to fourth embodiments, the description has given of the cases where the information processing device 100 executes main processing. In the fifth embodiment, the description will be given of a case where the mobile terminal has the same functions as the information processing device 100.

FIG. 12 is a block diagram showing functions of the mobile terminal in the fifth embodiment. For example, the mobile terminal 600 is a smartphone, a tablet terminal or an HMD. The mobile terminal 600 is referred to also as the information processing device.

The mobile terminal 600 includes a storage unit 610, an acquisition unit 620, a detection unit 630, an association unit 640, a state detection unit 650, an output unit 660, a generation unit 670, a storage control unit 680, an image capturing unit 690 and a display unit 691.

The storage unit 610 may be implemented as a storage area reserved in a volatile storage device or a nonvolatile storage device included in the mobile terminal 600.

Part or all of the acquisition unit 620, the detection unit 630, the association unit 640, the state detection unit 650, the output unit 660, the generation unit 670 and the storage control unit 680 may be implemented by processing circuitry included in the mobile terminal 600. Further, part or all of the acquisition unit 620, the detection unit 630, the association unit 640, the state detection unit 650, the output unit 660, the generation unit 670 and the storage control unit 680 may be implemented as modules of a program executed by a processor included in the mobile terminal 600.

The image capturing unit 690 is implemented by a camera of the mobile terminal 600, for example. The display unit 691 is implemented by a display device of the mobile terminal 600, for example.

First, the function of the image capturing unit 690 is described. The image capturing unit 690 captures an image of the board 300.

The functions of the acquisition unit 620, the detection unit 630, the association unit 640, the state detection unit 650, the generation unit 670 and the storage control unit 680 are the same as the functions of the acquisition unit 120, the detection unit 130, the association unit 140, the state detection unit 150, the generation unit 170 and the storage control unit 180. For example, the acquisition unit 620 acquires an image obtained by photographing the board 300. As above, the functions of the acquisition unit 620, the detection unit 630, the association unit 640, the state detection unit 650, the generation unit 670 and the storage control unit 680 are the same as the functions of the acquisition unit 120, the detection unit 130, the association unit 140, the state detection unit 150, the generation unit 170 and the storage control unit 180. Thus, the description is omitted for the functions of the acquisition unit 620, the detection unit 630, the association unit 640, the state detection unit 650, the generation unit 670 and the storage control unit 680.

The output unit 660 outputs the inspection result to the display unit 691. Accordingly, the display unit 691 displays the inspection result.

The mobile terminal 600 is capable of implementing the contents of the fourth embodiment. First, the display unit 691 is assumed to be displaying the inspection result as the detection result. The detection unit 630 detects via the image capturing unit 690 that the inspector has viewed the inspection result. The acquisition unit 620 acquires the positional relationship information indicating the positional relationship between the image capturing unit 690 and the display unit 691. Further, the acquisition unit 620 acquires the sight line information indicating the inspector's line of sight. The detection unit 630 detects an inspection target viewed by the inspector based on the positional relationship information, the sight line information, and an image obtained by the image capturing unit 690 by photographing the scene in the direction of the line of sight. The acquisition unit 620 acquires the information indicating that the inspector viewed the inspection result and the information indicating the inspection target viewed by the inspector. When the target of the inspection result viewed by the inspector (i.e., the inspection result displayed by the display unit 691) coincides with the inspection target viewed by the inspector (i.e., the inspection target detected by the detection unit 630) based on the information indicating that the inspector viewed the inspection result and the information indicating the inspection target viewed by the inspector, the storage control unit 680 stores the information indicating that the double check has been made in the storage unit 610. As above, the mobile terminal 600 is capable of implementing the contents of the fourth embodiment.

According to the fifth embodiment, the mobile terminal 600 achieves the same effects as the first to fourth embodiments.

Features in the embodiments described above can be appropriately combined with each other.

### DESCRIPTION OF REFERENCE CHARACTERS

100: information processing device, 101: processor, 102: volatile storage device, 103: nonvolatile storage device, 110: storage unit, 111: position table, 120: acquisition unit, 130: detection unit, 140: association unit, 150: state detection unit, 160: output unit, 170: generation unit, 180: storage control unit, 200: mobile terminal, 300: board, 301: nameplate, 302-304: switch, 305-307: lamp, 308, 309: meter, 400: image, 500: drawing reading device, 600: mobile terminal, 610: storage unit, 620: acquisition unit, 630: detection unit, 640: association unit, 650: state detection unit, 660: output unit, 670: generation unit, 680: storage control unit, 690: image capturing unit, 691: display unit

What is claimed is:

1. An information processing device comprising:
acquiring circuitry to acquire an image indicating a board including a name of the board and an inspection target and position information as information indicating a correspondence relationship among the name of the board, a position of the inspection target, and a name of the inspection target;
detecting circuitry to detect the board based on the image, detect the name of the board in an image region indicating the board, and detect the position of the inspection target based on the image region indicating the board;
associating circuitry to associate the board and the inspection target with each other based on the name of the board, the position of the inspection target, and the position information;
state detecting circuitry to detect a state of the inspection target in the image;
outputting circuitry to output an inspection result as a detection result;
a memory; and
storage controlling circuitry,
wherein
the acquiring circuitry acquires information indicating that a user viewed the inspection result and information indicating an inspection target viewed by the user, and
when a target of the inspection result viewed by the user coincides with the inspection target viewed by the user based on the information indicating that the user viewed the inspection result and the information indicating the inspection target viewed by the user, the storage controlling circuitry stores information indicating that a double check has been made in the memory.

2. The information processing device according to claim 1, further comprising:
a camera to capture an image of the board; and
a display device to display the inspection result.

3. The information processing device according to claim 1, wherein
the storage controlling circuitry stores the inspection result in the memory.

4. The information processing device according to claim 1, further comprising generating circuitry, wherein
the acquiring circuitry acquires a drawing indicating the board, and
the generating circuitry generates the position information based on the drawing indicating the board.

5. A support system comprising:
a mobile terminal including a camera to capture an image of a board including a name of the board and an inspection target; and
an information processing device, wherein
the information processing device includes:
acquiring circuitry to acquire an image generated by the mobile terminal and indicating the board and acquires position information as information indicating a correspondence relationship among the name of the board, a position of the inspection target, and a name of the inspection target;
detecting circuitry to detect the board based on the image, detect the name of the board in an image region indicating the board, and detect the position of the inspection target based on the image region indicating the board;
associating circuitry to associate the board and the inspection target with each other based on the name of the board, the position of the inspection target, and the position information;
state detecting circuitry to detect a state of the inspection target in the image;
outputting circuitry to output an inspection result as a detection result;
a memory; and
storage controlling circuitry,
wherein
the acquiring circuitry acquires information indicating that a user viewed the inspection result and information indicating an inspection target viewed by the user, and
when a target of the inspection result viewed by the user coincides with the inspection target viewed by the user based on the information indicating that the user viewed the inspection result and the information indicating the inspection target viewed by the user, the storage controlling circuitry stores information indicating that a double check has been made in the memory.

6. A support method performed by an information processing device including a memory, the support method comprising:
acquiring an image indicating a board including a name of the board and an inspection target and position information as information indicating a correspondence relationship among the name of the board, a position of the inspection target, and a name of the inspection target, detecting the board based on the image, detecting the name of the board in an image region indicating the board, detecting the position of the inspection target based on the image region indicating the board;
associating the board and the inspection target with each other based on the name of the board, the position of the inspection target, and the position information;
detecting a state of the inspection target in the image;
outputting an inspection result as a detection result;
acquiring information indicating that a user viewed the inspection result and information indicating an inspection target viewed by the user; and
when a target of the inspection result viewed by the user coincides with the inspection target viewed by the user based on the information indicating that the user viewed the inspection result and the information indicating the inspection target viewed by the user, storing information indicating that a double check has been made in the memory.

7. An information processing device comprising:
a processor to execute a program; and
a memory to store the program which, when executed by the processor, performs processes of,
acquiring an image indicating a board including a name of the board and an inspection target and position information as information indicating a correspondence relationship among the name of the board, a position of the inspection target, and a name of the inspection target, detecting the board based on the image, detecting the name of the board in an image region indicating the board, detecting the position of the inspection target based on the image region indicating the board,
associating the board and the inspection target with each other based on the name of the board, the position of the inspection target, and the position information,
detecting a state of the inspection target in the image,
outputting an inspection result as a detection result,
acquiring information indicating that a user viewed the inspection result and information indicating an inspection target viewed by the user, and
when a target of the inspection result viewed by the user coincides with the inspection target viewed by the user based on the information indicating that the user viewed the inspection result and the information indicating the inspection target viewed by the user, storing information indicating that a double check has been made in the memory.
